(19) United States
(12) Patent Application Publication
(10) Pub. No.: US 2021/0172468 A1
(43) Pub. Date: Jun. 10, 2021

(54) MECHANICAL FASTENER DRIVE TOOL AND SYSTEM

(71) Applicant: AR Developing, LLC, Chaplin, CT (US)

(72) Inventor: Alain Richard, Chaplin, CT (US)

(21) Appl. No.: 17/112,270

(22) Filed: Dec. 4, 2020

Related U.S. Application Data
(60) Provisional application No. 62/944,089, filed on Dec. 5, 2019.
(60) Provisional application No. 62/949,767, filed on Dec. 18, 2019.
(60) Provisional application No. 62/972,946, filed on Feb. 11, 2020.

(51) Int. Cl. F16B 23/00; B25B 15/00; B25B 23/12

(52) U.S. Cl. CPC F16B 23/0038; F16B 23/0092; B25B 23/12; B25B 15/004; F16B 23/0061

(57) ABSTRACT

A fastener is provided that includes a shank and a head disposed along a lengthwise axis. The head includes a first drive head and a second drive head. Both the first drive head and the second drive head are configured for engagement with at least one drive tool for rotationally driving the fastener about the lengthwise axis. The first drive head is configured differently than the second drive head.

This application claims priority to U.S. Provisional Patent Application No. 62/944,089 filed Dec. 5, 2019, and to U.S. Patent Provisional Patent Application No. 62/949,767 filed Dec. 18, 2019, and to U.S. Patent Provisional Patent Application No. 62/972,946 filed Feb. 11, 2020 all of which are herein incorporated by reference in their entirety.

### BACKGROUND OF THE INVENTION

### 1. Technical Field

The present application relates to mechanical fastener drive systems and related components.

### 2. Background Information

A mechanical fastener such as a bolt or screw includes a head portion and a shank portion. The head is configured to mate with a driving element (e.g., a wrench, socket, hex socket head drivers, double spline drivers, Torx drivers, etc.) and at least a portion of the shank is threaded. Some fasteners have a tapered threaded section that permits the fastener to positively engage a work piece. Other fasteners have a threaded shank that is configured to mate with a threaded element such as a nut.

Certain applications utilize two different types of mechanical fasteners. In the heating, ventilating, and air conditioning (HVAC) commercial industry for example it is common to use rectangular shaped sheet metal ducts as a conduit for forced air. These ducts are typically formed in sections, and a plurality of duct sections are secured together to form longer spans as needed. Each duct section may be described as having a length that defines the flow path through the duct section, a width that is orthogonal to the length, and a height that is orthogonal to the width and the length. When a duct section is formed, each wall of the sheet metal duct section is formed with an end flange extending outwardly (e.g., perpendicular to the lengthwise axis of the duct section). Hence, there is an end flange extending outwardly along each heightwise side wall and along each widthwise side wall, and these end flanges are disposed at each lengthwise end of the duct section. The duct sections are joined together by abutting the end flanges of contiguous duct sections and attaching the end flanges to one another.

Two different types of mechanical fasteners are typically used to install HVAC duct sections. A pair of corner flanges are typically disposed at each corner of the rectangular duct sections. The duct sections are typically attached to one another using corner flanges that are bolted to one another with bolt and nut pairs, with the end flanges of the respective sheet metal ducts clamped between the corner flanges. Self-tapping screws having a tapered shank section are often used to attach support strapping and other peripheral components to the duct sections. Very often the bolts used to attach the corner flanges to one another are larger (e.g., greater shank diameter and head size) than the self-tapping screws used to attach end flanges along the heightwise walls and widthwise walls. As a result, it is necessary to use two different tools to drive the corner flange bolts and the end flange screws. A person of ordinary skill in the HVAC industry will appreciate that HVAC duct sections are often assembled at heights (e.g., in or near the ceiling) and often the HVAC duct sections are surrounded by other structural elements within the building. Hence, the duct section installation process can be difficult, and is made more difficult by the need to utilize two different fastener drivers.

What is needed is a mechanical fastener drive system that can utilizes a single tool bit for driving two different fastener configurations.

### SUMMARY

According to an aspect of the present disclosure, a fastener is provided that includes a shank and a head disposed along a lengthwise axis. The head includes a first drive head and a second drive head. Both the first drive head and the second drive head are configured for engagement with at least one drive tool for rotationally driving the fastener about the lengthwise axis. The first drive head is configured differently than the second drive head.

In any of the aspects or embodiments described above and herein, the first drive head may be smaller than the second drive head.

In any of the aspects or embodiments described above and herein, the first drive head may be disposed at a first axial position along the lengthwise axis and the second drive head may be disposed at a second axial position along the lengthwise axis, and the first axial position is separated from the second axial position.

In any of the aspects or embodiments described above and herein, the first drive head may be disposed axially further away from the shank than the second drive head.

In any of the aspects or embodiments described above and herein, the second drive head may be disposed axially between the shank and the first drive head.

In any of the aspects or embodiments described above and herein, the first drive head may be configured as a first hexagon and the second drive head may be configured as a second hexagon, and the second hexagon is larger than the first hexagon.

In any of the aspects or embodiments described above and herein, at least a portion of the shank may be threaded.

In any of the aspects or embodiments described above and herein, the shank may include a tip end, and a portion of the shank extending from the tip end may be configured for self-threading.

In any of the aspects or embodiments described above and herein, the second drive head may include a cavity, and the first drive head is disposed within the cavity.

In any of the aspects or embodiments described above and herein, at least a portion of the second drive head may be disposed radially outside of the first drive head.

In any of the aspects or embodiments described above and herein, the first drive head may be configured as a first hexagon and the second drive head may be configured as a second hexagon, and the second hexagon is larger than the first hexagon.

According to another aspect of the present disclosure, a rotary tool bit having a lengthwise extending rotational axis is provided. The tool bit includes a shank and a head. The head is disposed at a lengthwise end of the shank. The head has a distal end surface and an exterior surface disposed radially outside the rotational axis, and the exterior surface is configured with a plurality of first engagement elements circumferentially spaced apart from one another the exterior surface. A female cavity is disposed in the distal end surface, and the female cavity is defined by an interior perimeter wall extending between the distal end surface and a base wall, wherein the interior perimeter wall is configured with a plurality of second engagement elements.

In any of the aspects or embodiments described above and herein, the first engagement elements may include a plurality of lobes and channels, and the channels and lobes are alternately disposed around a circumference of the head.

In any of the aspects or embodiments described above and herein, the lobes may extend radially outwardly.

In any of the aspects or embodiments described above and herein, the channels may extend radially inwardly.

In any of the aspects or embodiments described above and herein, the plurality of second engagement elements may be arranged so that at least a portion of the female cavity has a hexagonal shape.

In any of the aspects or embodiments described above and herein, the rotary tool bit may further include a magnet disposed in the base wall of the female cavity.

In any of the aspects or embodiments described above and herein, at least a portion of the first engagement elements may axially overlap with the plurality of second engagement elements.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a perspective view of a present disclosure rotary tool bit embodiment.

FIG. 2 is an end view of the present disclosure rotary tool bit embodiment shown in FIG. 1.

FIG. 3 is a diagrammatic partial sectional view of the present disclosure rotary tool bit embodiment shown in FIG. 1.

FIG. 4 is a diagrammatic perspective view of a first fastener embodiment.

FIG. 5 is a diagrammatic perspective view of a second fastener embodiment.

FIG. 6A is a diagrammatic planar side view of a fastener embodiment.

FIG. 6B is a top view of the fastener embodiment shown in FIG. 6A.

FIG. 7A is a diagrammatic planar side view of a fastener embodiment.

FIG. 7B is a top view of the fastener embodiment shown in FIG. 7A

FIG. 8A is a diagrammatic planar side view of a fastener embodiment. \

FIG. 8B is a top view of the fastener embodiment shown in FIG. 8A

FIG. 9A is a diagrammatic planar side view of a fastener embodiment.

FIG. 9B is a top view of the fastener embodiment shown in FIG. 9A

### DETAILED DESCRIPTION

The present disclosure system includes a rotary tool bit and fasteners configured to be rotationally driven; e.g., driven by a rotary tool bit as described herein, or by other rotational driver bit or tool. Some embodiments of the rotary tool bit have a double drive configuration that permits two different fastener configurations to be driven by the same rotary tool bit without any modifications to the rotary tool bit. The rotary tool bit includes a shank and a head.

The head of the rotary tool bit includes an exterior surface extending between a shank end and a distal end. The head exterior surface is configured to positively engage with a first fastener to permit the first fastener to be rotationally driven. For example, the head exterior surface may provide one half of a mating male and female combination with the fastener (e.g., a portion of the first fastener provides the opposite half of the mating male and female combination) to create the positive engagement there between. The head of the rotary tool bit further includes a female cavity disposed in a distal end surface. The female cavity is defined by an interior perimeter wall that is configured to positively engage with a second fastener to permit the second fastener to be rotationally driven. For example, the interior perimeter wall may provide one half of a mating male and female combination with the second fastener (e.g., a portion of the second fastener provides the opposite half of the mating male and female combination) to create the positive engagement there between. The description below details an example of a rotary tool bit configuration to illustrate the utility of the present disclosure. The present disclosure is not, however, limited to this particular example.

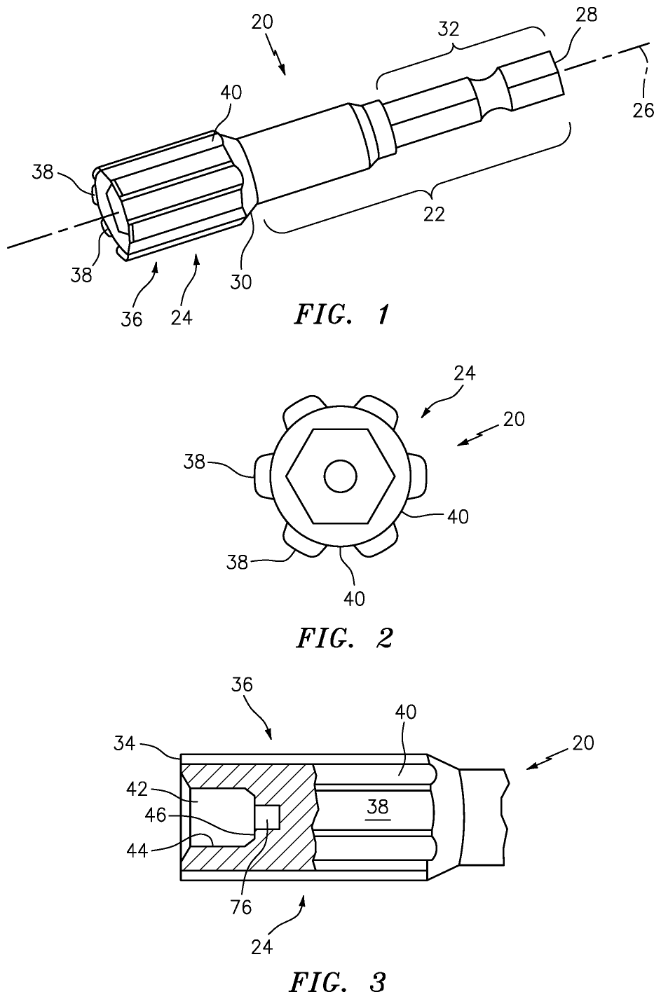

A non-limiting example of a rotary tool bit 20 is shown in FIGS. 1-3. The rotary tool bit 20 includes a shank 22 and a head 24, extending along a lengthwise axis 26. The shank 22 extends lengthwise between a butt end 28 and a head end 30. A portion of the shank 22 adjacent the butt end 28 (i.e., “grip portion 32”) is configured to be gripped in a rotational driving tool; e.g., gripped in the chuck of the tool (not shown). The grip portion 32 may be cylindrical, or non-cylindrical; e.g., the example shown in FIG. 1 shows a grip portion 32 having a plurality of planar surfaces that facilitate being gripped within a clamping device. The present disclosure is not limited to any particular grip portion 32 configuration.

The rotary tool bit head 24 extends lengthwise between the head end 30 of the shank 22 and a distal end surface 34, and includes a circumferential exterior surface 36 centered on lengthwise axis 26. The exterior surface 36 is configured to positively engage with a first fastener to permit the first fastener to be rotationally driven. The exterior surface 36 defines the male portion of a mating male and female combination. As will be described below, the head of the first fastener defines the female portion of this mating male and female combination. The exemplary rotary tool bit 20 shown in FIGS. 1-3 includes an exterior surface 36 configured with a plurality of engagement elements for positive engagement with the first fastener. In embodiment shown in FIGS. 1-3, the engagement elements include a plurality of axially extending lobes 38 and channels 40. The lobes 38 may be described as extending radially outwardly, spaced apart from one another around the circumference of the rotary tool bit head 24 with a channel 40 disposed between each adjacent pair of lobes 38; i.e., the lobes 38 and channels 40 are alternately disposed around the circumference of the head 24. Conversely, the channels 40 may be described as extending radially inwardly, spaced apart from one another around the circumference of the rotary tool bit head 24 with a lobe 38 disposed between each adjacent pair of channels 40. The lobes 38 and channels 40 are an example of a male configuration operable to positively engage with a first fastener to permit the first fastener to be rotationally driven. The present disclosure is not limited to the lobe 38 and channel 40 configuration shown in FIG. 3.

The rotary tool bit head 24 includes a female cavity 42 disposed in the distal end surface 34. The female cavity 42 is defined by an interior perimeter wall 44 extending between the distal end surface 34 and a base wall 46. The interior perimeter wall 44 is configured to positively engage with a second fastener to permit the second fastener to be rotationally driven. The female cavity 42 is a female portion of a mating male and female combination. As will be described below, the head of a second fastener (e.g., a self-tapping screw as shown in FIG. 5) is the male portion of this mating male and female combination. The exemplary rotary tool bit 20 shown in FIGS. 1-3 includes an interior perimeter wall 44 configured as a hexagon; e.g., the interior perimeter wall 44 surfaces that form the hexagon may be referred to as engagement elements. In some embodiments, at least a portion of the engagement elements (e.g., lobes 38 and channels 40) of the exterior surface 36 axially overlap with the engagement elements of the interior perimeter wall 44. During use, the hexagonal head of the second fastener is received within the female cavity 42. The interior perimeter wall 44 of the female cavity 42 (i.e., the female portion) mates with the head of the screw (i.e., the male portion) and creates a positive engagement there between. Once the head of the screw is received within the female cavity 42 of the rotary tool bit head 24, rotation of the rotary tool bit 20 will cause rotation of the screw in the same rotational direction. The present disclosure is not limited to any particular mating geometry between the rotary tool bit head female cavity 42 and the head of the second fastener; i.e., the present disclosure rotary tool bit head female cavity 42 may have a configuration other than hexagonal.

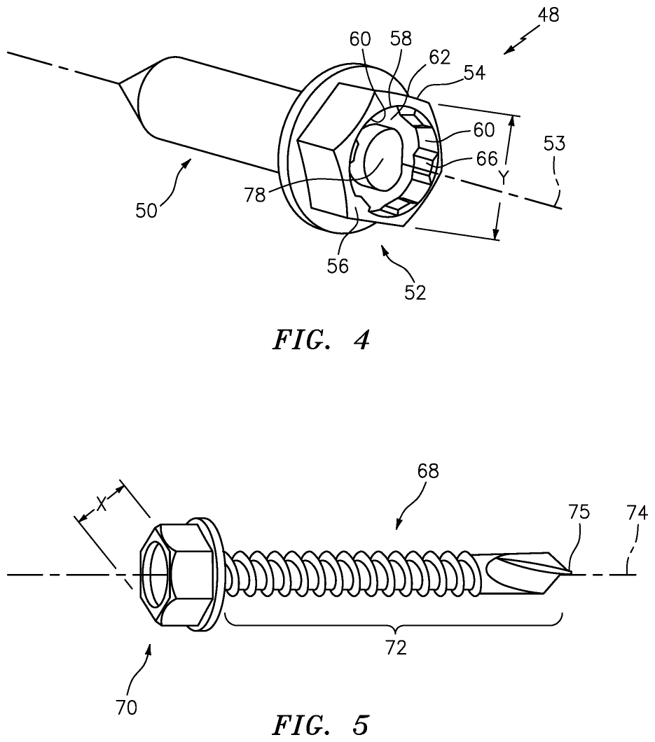

Referring to FIG. 4, as indicated above, the rotary tool bit 20 may be used to drive a first fastener; e.g., bolt 48. The bolt 48 includes a shank 50 and a head 52, extending along a lengthwise extending axis 53. At least a portion of the shank 50 is threaded; e.g., threads configured for self-threading into a substrate; e.g., a metallic substrate. The term “self-threading” as used herein refers to a thread type configured to engage and create mating threads in a workpiece that does not include mating threads prior to engagement with the self-threading threads. The head 52 of the bolt 48 has an exterior engagement surface 54 and an end surface 56. The exterior engagement surface 54 typically has a standard bolt head configuration; e.g., a U.S. or metric sized hexagonal head or the like. A female cavity 58 is disposed within the end surface 56 of the bolt head 52. The female cavity 58 has an interior perimeter wall 60 and a base wall 62. The interior perimeter wall 60 is configured to positively engage with a rotary tool bit to permit the bolt 48 to be rotationally driven. The female cavity 58 is the female portion of a mating male and female combination; i.e., using the rotary tool bit 20 described above as an example, the interior perimeter wall 60 has channels 64 configured to receive the lobes 38 of the rotary tool bit head exterior surface 36, and lobes 66 configured to be received within the channels 40 of the rotary tool bit head exterior surface 36.

Referring to FIG. 5, as indicated above, the rotary tool bit 20 may be used to drive a second fastener. For HVAC applications, the second fastener is typically a commercially available screw; e.g., a screw 68 having a head 70 and a threaded shank 72, extending along a lengthwise extending axis 74, with self-tapping threads disposed at a tip 75 for engaging a metallic substrate such as sheet metal. The head 70 of the screw 68 typically has a standard configuration; e.g., a U.S. or metric sized hexagonal head or the like. The screw 68 is typically a different size fastener than the bolt 48, with a head 70 that is smaller than the head 52 of the bolt 48. The example screw 68 shown in FIG. 5 has a hexagonal shaped head 70 having opposing surfaces spaced apart from one another by the dimension “X”, whereas the example bolt 48 shown in FIG. 4 has a hexagonal shaped head 52 having opposing surfaces spaced apart from one another by the dimension “Y”, where “Y” is greater than “X”.

In terms of the rotary tool bit 20 described above, the head 70 of the second fastener (e.g., self-tapping screw 68) is the male portion of the mating male and female combination with the rotary tool bit head female cavity 42. During use, the head 70 of the screw 68 is received within the female cavity 42. The interior perimeter wall 60 of the female cavity 42 (i.e., the female portion) mates with the head 70 of the screw 68 (i.e., the male portion) and creates a positive engagement there between. Once the head 70 of the screw 68 is received within the female cavity 42 of the rotary tool bit head 24, rotation of the rotary tool bit 20 will cause rotation of the screw 68 in the same rotational direction. The present disclosure is not limited to any particular mating geometry between the rotary tool bit head female cavity 42 and the head 70 of the screw 68.

In some embodiments, the rotary tool bit head 24 may include a magnet 76 disposed in the base wall 46 of the female cavity 42 (See FIG. 4). In those embodiments that include a magnet 76, the magnet 76 is disposed to be in close proximity to the head 70 of the screw 68 when the aforesaid head 70 is disposed within the female cavity 42 of the rotary tool bit head 24. When metallic screws 68 are used, the magnet 76 exerts sufficient magnetic attraction to retain the head 70 of the screw 68 within the female cavity 42 and thereby couple the rotary tool bit 20 and screw 68 together. As a result, hands free installation of a screw 68 is facilitated.

In some embodiments wherein the rotary tool bit head 24 includes a magnet 76, the bolt 48 may include a post 78 extending outwardly from the base wall 62 of the female cavity 42 (e.g., see FIG. 4). The post 78 is configured to be in close proximity to the magnet 76 disposed in the base wall 46 of the female cavity 42 of the rotary tool bit head 24 when the rotary tool bit head 24 is received within the female cavity 58 of the bolt head 52. When metallic bolts 48 are used, the magnet 76 exerts sufficient magnetic attraction to couple the bolt 48 and the rotary tool bit 20 together. As a result, hands free installation of a bolt 48 is facilitated.

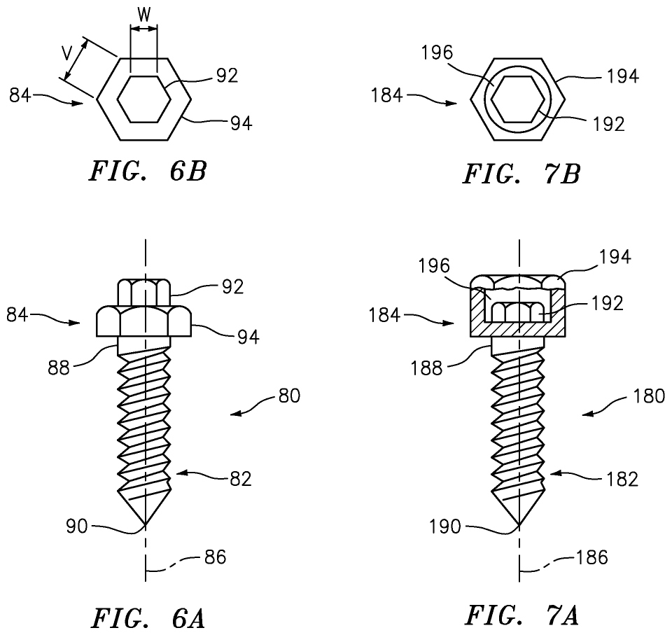

FIGS. 6-9B illustrate fastener embodiments according to aspects of the present disclosure. As indicated above, two different types of mechanical fasteners are typically used to install duct sections (e.g., corner flange bolts for connecting duct sections and self-tapping screws for attaching duct support strapping, peripheral flanges, etc.), and very often the bolts used to attach the corner flanges to one another are larger than the self-tapping screws. As a result, under the prior art it is necessary to use two different tools to drive the corner flange bolts and the end flange screws. A person of skill in the art will recognize that HVAC duct work systems are very often mounted and/or installed in the ceiling area of a building, in and around other mechanical system components present within the building. Hence, the installation/mounting work is done at elevated heights and very often in confined spaces that are difficult to work in for a technician. The need to use multiple tools, or to frequently modify a rotational driving tool, as is often the case with prior art systems compounds the degree of difficulty. The fastener embodiments according to the present disclosure, such as but not limited to those shown in FIGS. 6-9B, provide an alternative solution to this issue, one that facilitates the HVAC duct installation/mounting work.

The fastener shown in FIGS. 6A and 6B illustrates a fastener 80 in the form of a bolt that has a shank 82 and a head 84 extending along a lengthwise extending axis 86. The shank 82 extends lengthwise between a head end 88 and a tip end 90. In some embodiments, a portion of the shank 82 (extending from the tip end 90) includes threads configured for self-threading into a substrate; e.g., a metallic substrate. The shank 82 may be threaded for all, or less than all, of the entirety of the lengthwise distance between the head end 88 and the tip end 90. The head 84 includes a first drive head 92 and a second drive head 94. The first drive head 92 is exposed, and disposed axially outside of the second drive head 94; e.g., the first drive head 92 may be described as being disposed at a first axial position and the second drive head 94 disposed at a second axial position, and the first axial position is different/separated from the second axial position. The first drive head 92 is configured for positive engagement with a rotational driving tool (e.g., a rotary tool bit, or a socket, etc.). Non-limiting examples of a first drive head 92 configuration include a standard bolt head configuration (e.g., a U.S. or metric sized hexagonal head), or the like. In some embodiments, the first drive head 92 may have the same configuration as the drive head of the self-tapping screws typically used in HVAC applications; e.g., a 5/16 inch hexagonal head. The present disclosure is not limited to any particular first drive head 92 size or configuration. The second drive head 94 extends axially between the first drive head 92 and the shank 82. The second drive head 94 is configured for positive engagement with a rotational driving tool (e.g., a rotary tool bit, or a socket, etc.). Non-limiting examples of a second drive head 94 configuration include a standard bolt head configuration (e.g., a U.S. or metric sized hexagonal head), or the like. In some embodiments, the second drive head 94 may have the same configuration as the drive head of a bolt typically used to secure HVAC duct corner brackets together; e.g., a 9/16 inch or ⅝ inch hexagonal head. Hence, the second drive head 94 may be configured larger than the first drive head 92 (e.g., a 9/16 inch or ⅝ inch hexagonal head versus a 5/16 inch hexagonal head). FIG. 6B diagrammatically illustrates the first and second drive head 92, 94 differences by indicating the first drive head has a hexagonal side dimension of “W” and the second drive head has a hexagonal side dimension of “V”, where V is greater than W (V>W). The fastener 80 may, therefore, be driven using either a rotational driving tool configured to drive the first drive head 92 or the second drive head 94. The present disclosure is not limited to any particular second drive head 94 size or configuration.

FIGS. 7A and 7B illustrate another fastener embodiment according to the present disclosure. The fastener 180 is in the form of a bolt that includes a shank 182 and a head 184 extending along a lengthwise axis 186. The shank 182 extends lengthwise between a head end 188 and a tip end 190. In some embodiments, a portion of the shank 182 (extending from the tip end 190) includes threads configured for self-threading into a substrate; e.g., a metallic substrate. The shank 182 may be threaded for all, or less than all, of the entirety of the lengthwise distance between the head end 188 and the tip end 190. The head 184 includes a first drive head 192 and a second drive head 194. The first drive head 192 is configured for positive engagement with a rotational driving tool (e.g., a rotary tool bit, or a socket, etc.). Non-limiting examples of a first drive head 192 configuration include a standard bolt head configuration (e.g., a U.S. or metric sized hexagonal head), or the like. In some embodiments, the first drive head 192 may have the same configuration as the drive head of the self-tapping screws typically used in HVAC applications; e.g., a 5/16 inch hexagonal head. The present disclosure is not limited to any particular first drive head 192 size or configuration. The first drive head 192 is disposed within a cavity 196 disposed within the second drive head 194. In some embodiments, the first drive head 192 may be described as being disposed at a first axial position and the second drive head 194 disposed at a second axial position, and at least a portion of the second axial position overlaps (i.e., is radially outside of) the first axial position. The cavity 196 is sized to allow entry of a drive tool (e.g., a socket) for engagement with the first drive head 192. The second drive head 194 is configured for positive engagement with a rotational driving tool (e.g., a rotary tool bit, or a socket, etc.). Non-limiting examples of a second drive head 194 configuration include a standard bolt head configuration (e.g., a U.S. or metric sized hexagonal head), or the like. In some embodiments, the second drive head 194 may have the same configuration as the drive head of a bolt typically used to secure HVAC duct corner brackets together; e.g., a 9/16 inch or a ⅝ inch hexagonal head. The present disclosure is not limited to any particular second drive head 194 size or configuration.

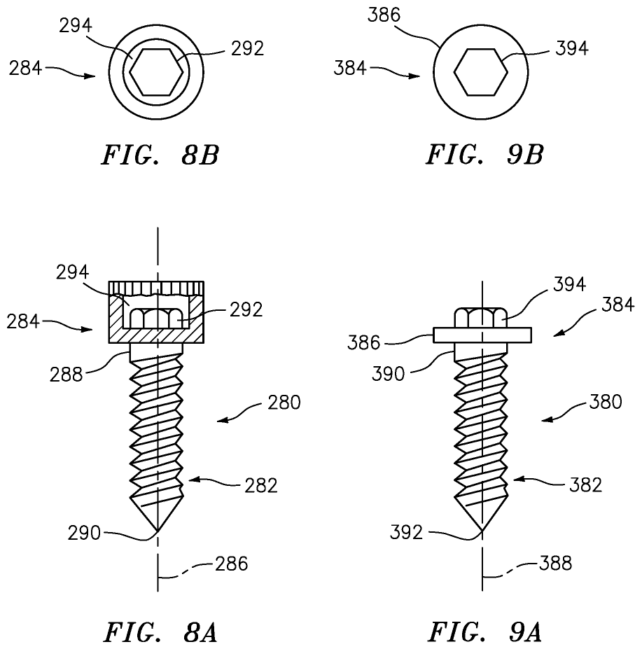

FIGS. 8A and 8B illustrate another fastener embodiment according to the present disclosure. The fastener 280 is in the form of a bolt that includes a shank 282 and a head 284 extending along a lengthwise axis 286. The shank 282 extends lengthwise between a head end 288 and a tip end 290. In some embodiments, a portion of the shank 282 (extending from the tip end 290) may include threads configured for self-threading into a substrate; e.g., a metallic substrate. The shank 282 may be threaded for all, or less than all, of the entirety of the lengthwise distance between the head end 288 and the tip end 290. The head 284 includes a drive head 292 disposed within a cavity 294 disposed within the head 284 of the fastener 280. The drive head 292 is configured for positive engagement with a rotational driving tool (e.g., a rotary tool bit, or a socket, etc.). Non-limiting examples of a drive head 292 configuration include a standard bolt head configuration (e.g., a U.S. or metric sized hexagonal head), or the like. In some embodiments, the drive head 292 may have the same configuration as the drive head of the self-tapping screws typically used in HVAC applications; e.g., a 5/16 inch hexagonal head. The present disclosure is not limited to any particular drive head 292 size or configuration. The cavity 294 is sized to allow entry of a drive tool (e.g., a socket) for engagement with the drive head 292. The exterior surface of the fastener head 284 may not be configured to be driven.

FIGS. 9A and 9B illustrate another fastener embodiment according to the present disclosure. The fastener 380 is in the form of a bolt that includes a shank 382, a head 384, and a flange portion 386 disposed there between. The shank 382 and head 384 extend along a lengthwise axis 388. The shank 382 extends lengthwise between a head end 390 and a tip end 392. In some embodiments, a portion of the shank 382 (extending from the tip end 392) may include threads configured for self-threading into a substrate; e.g., a metallic substrate. The shank 382 may be threaded for all, or less than all, of the entirety of the lengthwise distance between the head end 390 and the tip end 392. The fastener head 384 includes a drive head 394 disposed on an axial side of the flange portion 386, opposite the shank 382. The flange portion 386 extends radially outward a greater distance than the drive head 394 and the shank 382. The drive head 394 is configured for positive engagement with a rotational driving tool (e.g., a rotary tool bit, or a socket, etc.). Non-limiting examples of a drive head 394 configuration include a standard bolt head configuration (e.g., a U.S. or metric sized hexagonal head), or the like. In some embodiments, the drive head 394 may have the same configuration as the drive head of the self-tapping screws typically used in HVAC applications; e.g., a 5/16 inch hexagonal head. The present disclosure is not limited to any particular drive head 394 size or configuration.

In each of the fastener embodiments shown in FIGS. 6-9B, the fastener 80, 180, 280, 380 may be a unitary body. The fastener 80, 180, 280, 380 may include one or more coatings; e.g., oxidation preventative coatings, etc.

In each of the fastener embodiments shown in FIGS. 6-9B, a single drive tool (e.g., a socket) can be used to drive both the corner flange bolts and self-tapping screws typically used in HVAC applications. Consequently, the need for the installer to continuously change drive tools is eliminated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A fastener, comprising:
a shank and a head disposed along a lengthwise axis;
the head including a first drive head and a second drive head;
wherein both the first drive head and the second drive head are configured for engagement with at least one drive tool for rotationally driving the fastener about the lengthwise axis; and
wherein the first drive head is configured differently than the second drive head.

2. The fastener of claim 1, wherein the first drive head is smaller than the second drive head.

3. The fastener of claim 2, wherein the first drive head is disposed at a first axial position along the lengthwise axis and the second drive head is disposed at a second axial position along the lengthwise axis, and the first axial position is separated from the second axial position.

4. The fastener of claim 3, wherein the first drive head is disposed axially further away from the shank than the second drive head.

5. The fastener of claim 3, wherein the second drive head is disposed axially between the shank and the first drive head.

6. The fastener of claim 1, wherein the first drive head is configured as a first hexagon and the second drive head is configured as a second hexagon, and the second hexagon is larger than the first hexagon.

7. The fastener of claim 1, wherein at least a portion of the shank is threaded.

8. The fastener of claim 7, wherein the shank includes a tip end, and a portion of the shank extending from the tip end is configured for self-threading.

9. The fastener of claim 1, wherein the second drive head includes a cavity, and the first drive head is disposed within the cavity.

10. The fastener of claim 9, wherein at least a portion of the second drive head is disposed radially outside of the first drive head.

11. The fastener of claim 9, wherein the first drive head is configured as a first hexagon and the second drive head is configured as a second hexagon, and the second hexagon is larger than the first hexagon.

12. The fastener of claim 9, wherein at least a portion of the shank is threaded.

13. The fastener of claim 12, wherein the shank includes a tip end, and a portion of the shank extending from the tip end is configured for self-threading.

14. A rotary tool bit having a lengthwise extending rotational axis, the tool bit comprising:
a shank;
a head disposed at a lengthwise end of the shank, the head having a distal end surface and an exterior surface disposed radially outside the rotational axis, and the exterior surface is configured with a plurality of first engagement elements circumferentially spaced apart from one another the exterior surface;
wherein a female cavity is disposed in the distal end surface, and the female cavity is defined by an interior perimeter wall extending between the distal end surface and a base wall, wherein the interior perimeter wall is configured with a plurality of second engagement elements.

15. The rotary tool bit of claim 14, wherein the first engagement elements include a plurality of lobes and channels, and the channels and lobes are alternately disposed around a circumference of the head.

16. The rotary tool bit of claim 15, wherein the lobes extend radially outwardly.

17. The rotary tool bit of claim 15, wherein the channels extend radially inwardly.

18. The rotary tool bit of claim 15, wherein the plurality of second engagement elements are arranged so that at least a portion of the female cavity has a hexagonal shape.

19. The rotary tool bit of claim 14, further comprising a magnet disposed in the base wall of the female cavity.

20. The rotary tool bit of claim 14, wherein at least a portion of the first engagement elements axially overlap with the plurality of second engagement elements.
